(19) United States
(12) Patent Application Publication
(10) Pub. No.: US 2016/0365565 A1
(43) Pub. Date: Dec. 15, 2016

(54) NEGATIVE PLATE FOR LITHIUM SECONDARY BATTERY

(71) Applicant: ILJIN ELECTRIC CO., LTD., Hwaseong (KR)

(72) Inventors: Cheol Ho Park, Gwangmyeong (KR); Seon Kyong Kim, Seoul (KR)

(73) Assignee: ILJIN ELECTRIC CO., LTD., Hwaseong (KR)

(21) Appl. No.: 15/104,379

(22) PCT Filed: Dec. 9, 2014
(86) PCT No.: PCT/KR2014/012086

§ 371 Date: Jun. 14, 2016

(30) Foreign Application Priority Data
Dec. 24, 2013 (KR) 10-2013-0163121

(51) Int. Cl. H01M 4/134; H01M 4/62; H01M 4/133; H01M 4/583; H01M 10/0525; H01M 4/38

(52) U.S. Cl. CPC H01M 4/134; H01M 10/0525; H01M 4/386; H01M 4/133; H01M 4/583; H01M 4/622; H01M 4/624; H01M 4/62; H01M 2004/027

(57) ABSTRACT

A negative plate for a lithium secondary battery according to an exemplary embodiment of the present invention includes: a negative active material including a silicon (Si) alloy; a binder; and a single-walled carbon nano tube (SWCNT) dispersion liquid, the ratio of the SWCNT dispersion liquid to the silicon (Si) alloy included in the negative plate for the lithium secondary battery is 800:3 to 20:1.

### TECHNICAL FIELD

The present invention relates to a negative plate for a lithium secondary battery, and more particularly, to a negative plate for a lithium secondary battery having a high plate capacity and excellent efficiency.

### BACKGROUND ART

A lithium battery in the related art uses a lithium metal as a negative active material, but when a lithium metal is used, a battery is short-circuited by formation of dendrite to cause danger of explosion, so that a carbon-based material is widely used as a negative active material, instead of a lithium metal.

The carbon-based active material includes crystalline carbon, such as natural graphite and artificial graphite, and amorphous carbon, such as soft carbon and hard carbon. However, the amorphous carbon has a large capacity, but has a problem in that irreversibility is large during a charging/discharging process. Graphite is representatively used as the crystalline carbon, and has a theoretical limit capacity of 372 mAh/g, which is large, so that the graphite is used as a negative active material.

In order to develop a next-generation high capacity lithium battery, a development of a negative active material having a high capacity beyond the capacity of graphite is essential. To this end, a material, which is currently and actively researched, is a negative active material using a silicon alloy. The silicon has a high capacity and a high energy density, and capable of occluding and discharging more lithium ions than the negative active material using the carbon-based material, so that it is possible to manufacture a secondary battery having a high capacity and a high energy density.

However, when a negative plate for a lithium secondary battery is manufactured by using a silicon-based negative active material, a binder essentially used for manufacturing the negative plate causes an irreversible reaction, so that there is a problem in that a capacity, initial efficiency, and a life characteristic of the negative plate are degraded.

### DISCLOSURE

### Technical Problem

An object of the present invention is to provide a negative plate for a lithium secondary battery, which is capable of implementing a secondary battery having a high capacity and excellent initial efficiency.

Another object of the present invention is to provide a negative plate for a lithium secondary battery, which is capable of implementing a secondary battery having an improved life characteristic.

Objects of the present invention are not limited to the objects described above, and other objects that are not described will be clearly understood by a person skilled in the art from the description below.

### Technical Solution

In order to achieve the aforementioned object, a negative plate for a lithium secondary battery according to an exemplary embodiment of the present invention includes: a negative active material including a silicon (Si) alloy; a binder; and a single-walled carbon nano tube (SWCNT) dispersion liquid, the ratio of the SWCNT dispersion liquid to the silicon (Si) alloy included in the negative plate for the lithium secondary battery is 800:3 to 20:1.

The ratio of the SWCNT dispersion liquid to the silicon (Si) alloy included in the negative plate for the lithium secondary battery may be 160:1 to 80:3.

Silicon (Si) may be included in the silicon (Si) alloy by 40 at % to 70 at %.

The negative active material may further include graphite.

The binder may be included in the negative plate for the lithium secondary battery by 1 to 10 at %.

The negative plate may further include a thickener of 0.01 to 2 at %.

The negative plate may further include a conductive agent of 0.01 to 5 at %.

Other detailed matters of the embodiments are included in the detailed description and the drawings.

### Advantageous Effects

The present invention has an effect in carrying out a secondary battery having a high capacity and excellent initial efficiency.

The present invention has an effect in carrying out a secondary battery having an improved life characteristic.

Objects of the present invention are not limited to the objects described above, and other objects that are not described will be clearly understood by a person skilled in the art from the description below.

### DESCRIPTION OF DRAWINGS

FIG. 1 is a table representing a comparison of a component ratio between a negative plate for a lithium secondary battery of Example 1 and a negative plate for a lithium secondary battery of Comparative Example 1.

FIG. 2 is a table representing a comparison of a component ratio between a negative plate for a lithium secondary battery of Example 2 and a negative plate for a lithium secondary battery of Comparative Example 2.

FIG. 3 is a table representing a plate capacity, an active material capacity, and initial efficiency of the negative plates for a lithium secondary battery manufactured in Example 1 and Comparative Example 1.

FIGS. 4A to 4C are graphs representing a life characteristic of the negative plates for a lithium secondary battery manufactured in Example 1 and Comparative Example 1.

FIGS. 5A to 5C are graphs representing a life characteristic of the negative plates for a lithium secondary battery manufactured in Example 2 and Comparative Example 2.

### BEST MODE

In order to achieve the aforementioned object, a negative plate for a lithium secondary battery according to an exemplary embodiment of the present invention includes: a negative active material including a silicon (Si) alloy; a binder; and a single-walled carbon nano tube (SWCNT) dispersion liquid, the ratio of the SWCNT dispersion liquid to the silicon (Si) alloy included in the negative plate for the lithium secondary battery is 800:3 to 20:1.

### Mode for Carrying out the Invention

Advantages and features of the present disclosure and methods accomplishing the advantages and features will become apparent from the following detailed description of exemplary embodiments with reference to the accompanying drawings. However, the present invention is not limited to exemplary embodiment disclosed herein but will be implemented in various forms. The exemplary embodiments are provided so that the present invention is completely disclosed, and a person of ordinary skilled in the art can fully understand the scope of the present invention. Therefore, the present invention will be defined only by the scope of the appended claims.

Respective characteristics of several exemplary embodiments of the present disclosure may be partially or entirely coupled or combined, and technically and variously connected and driven enough for those skilled in the art to fully understand, and respective exemplary embodiments may be independently carried out, and implemented together according to an associated relation.

The term “approximate” used in the present specification is used as a numerical value or a meaning close to the numerical value when an unique manufacturing and material allowable error is suggested to a mentioned meaning, and is used for preventing an unconscionable infringer from illegally using the disclosed contents including an accurate or absolute numerical value mentioned for helping the understanding of the present invention.

A unit “%” used in the present specification means “atom %” unless otherwise regulated.

The present invention provides a negative plate for a lithium secondary battery including a negative active material including a silicon (Si) alloy, a binder, and a single-walled carbon nano tube (SWCNT) dispersion liquid.

In the present invention, the silicon (Si) alloy is a negative active material, and may involve in occlusion and discharge of lithium ions.

The silicon (Si) alloy is an alloy including silicon (Si), and the kind of silicon alloy is not particularly limited. The silicon (Si) alloy basically includes silicon (Si), and may be an alloy further including one or more elements of aluminum (Al), nickel (Ni), cobalt (Co), iron (Fe), copper (Cu), chrome (Cr), zirconium (Zr), titanium (Ti), and manganese (Mn). In the silicon (Si) alloy, silicon (Si) may be included by 40 at % to 80 at %.

The binder serves to increase binding force between components configuring the negative plate for the lithium secondary battery. The binder may be a Styrene-Butadiene Rubber (SBR)-based binder, but is not essentially limited thereto.

The binder may be included in the negative plate for the lithium secondary battery by 1 to 10 at %, but is not essentially limited thereto.

The SWCNT dispersion liquid is included in the negative plate for the lithium secondary battery by a small quantity (particularly, a ratio of the SWCNT dispersion liquid to the silicon (Si) alloy is 800:3 to 20:1) to serve improve a capacity, initial efficiency, and a life characteristic of the negative plate for the lithium secondary battery.

The Carbon Nano Tube CNT has a graphite sheet rolled in a diameter at a nanometer level, and may have various structures according to a rolled angle and a form of the graphite sheet. The SWCNT refers to a CNT, in which the graphite sheet is formed in a single layer, and may be discriminated with a multi-layered carbon nano tube (MWCNT), in which the graphite sheets are formed in multiple layers.

A ratio of the SWCNT dispersion liquid added to the negative plate for the lithium secondary battery may be changed according to the ratio of the silicon (Si) alloy added to the negative plate for the lithium secondary battery. Particularly, when the ratio of the silicon (Si) alloy added is increased, the ratio of the SWCNT dispersion liquid added may also be increased together, and when the ratio of the silicon (Si) alloy added is decreased, the ratio of the SWCNT dispersion liquid added may also be decreased together.

The ratio of the SWCNT dispersion liquid to the silicon (Si) alloy included in the negative plate for the lithium secondary battery may be 800:3 to 20:1, and preferably, 160:1 to 80:3. Accordingly, when the silicon (Si) alloy is mixed in a ratio of 8 at %, the SWCNT dispersion liquid may be mixed in a ratio of 0.03 at % to 0.4 at %, preferably, a ratio of 0.05 at % to 0.3 at %.

The negative active material may further include graphite, in addition to the silicon (Si) alloy. The graphite, which is a negative active material, may involve in occlusion and discharging of lithium ions. The ratio of the graphite to the silicon (Si) alloy included in the negative active material is not particularly limited, and the silicon (Si) alloy and the graphite may be mixed in various ratios according to an implementation method.

The negative plate for the lithium secondary battery may selectively further include a thickener of 0.01 to 2 at %. The thickener serves to increase viscosity of the components configuring the negative plate for the lithium secondary battery. The thickener may be a carboxymethyl cellulose (CMC)-based thickener, but is not essentially limited thereto.

The negative plate for the lithium secondary battery may selectively further include a conductive agent of 0.01 to 5 at %. The conductive agent may serve to improve electric conductivity of the negative plate for the lithium secondary battery.

### EXAMPLE 1

A method of manufacturing a negative plate of the present invention is not particularly limited, and a negative plate may be manufactured by using various methods of manufacturing a negative plate generally and publicly known in the art.

In Example 1, after a silicon (Si) alloy having a composition of Si₅₀(Cu₅₀Al₅₀)₄₅Fe₅ was fabricated, a negative plate for a lithium secondary battery was manufactured by mixing the silicon (Si) alloy in a ratio of 8 at %, a CMC-based thickener in a ratio of 1 at %, an SBR-based binder in a ratio of 2 at %, and graphite in the remaining ratio were mixed, and further mixing the SWCNT dispersion liquid of 0.03 at % to 0.3 at %.

### EXAMPLE 2

In Example 2, after a silicon (Si) alloy having a composition of

Si₅₀(Cu₅₀Al₅₀)₄₅Fe₅ was fabricated, a negative plate for a lithium secondary battery was manufactured by mixing the silicon (Si) alloy in a ratio of 5.8 at %, a CMC-based thickener in a ratio of 1 at %, an SBR-based binder in a ratio of 2 at %, and graphite in the remaining ratio were mixed, and further mixing the SWCNT dispersion liquid of 0.03 at % to 0.10 at %.

### Comparative Example 1

In Comparative Example 1, after a silicon (Si) alloy having a composition of Si₅₀(Cu₅₀Al₅₀)₄₅Fe₅ was fabricated, a negative plate for a lithium secondary battery was manufactured by mixing the silicon (Si) alloy in a ratio of 5.8 at %, a CMC-based thickener in a ratio of 1 at %, an SBR-based binder in a ratio of 2 at %, and graphite in the remaining ratio were mixed, and then the SWCNT dispersion liquid was not mixed at all, and the SWCNT dispersion liquid of 0.01 at % to 0.5 at % was further mixed.

### Comparative Example 2

In Comparative Example 2, after a silicon (Si) alloy having a composition of Si₅₀(Cu₅₀Al₅₀)₄₅Fe₅ was fabricated, a negative plate for a lithium secondary battery was manufactured by mixing the silicon (Si) alloy in a ratio of 5.8 at %, a CMC-based thickener in a ratio of 1 at %, an SBR-based binder in a ratio of 2 at %, and graphite in the remaining ratio were mixed, and then the SWCNT dispersion liquid was not mixed at all, and the SWCNT dispersion liquid of 0.01 at % was further mixed.

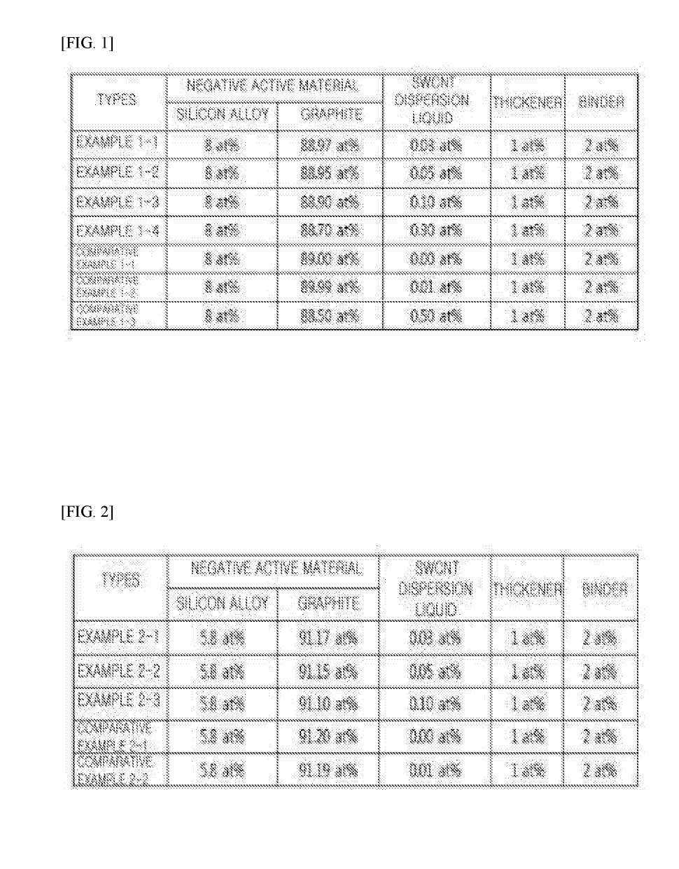

FIG. 1 is a table representing a comparison of a component ratio between the negative plate for the lithium secondary battery of Example 1 and the negative plate for the lithium secondary battery of Comparative Example 1.

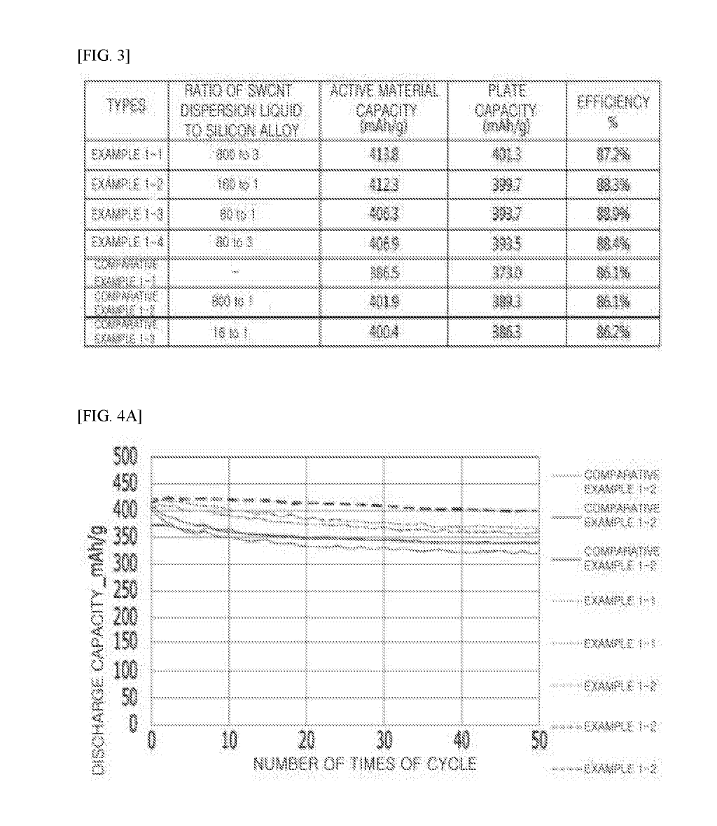

FIG. 2 is a table representing a comparison of a component ratio between the negative plate for the lithium secondary battery of Example 2 and the negative plate for the lithium secondary battery of Comparative Example 2.

1. Plate Capacity and Initial Efficiency

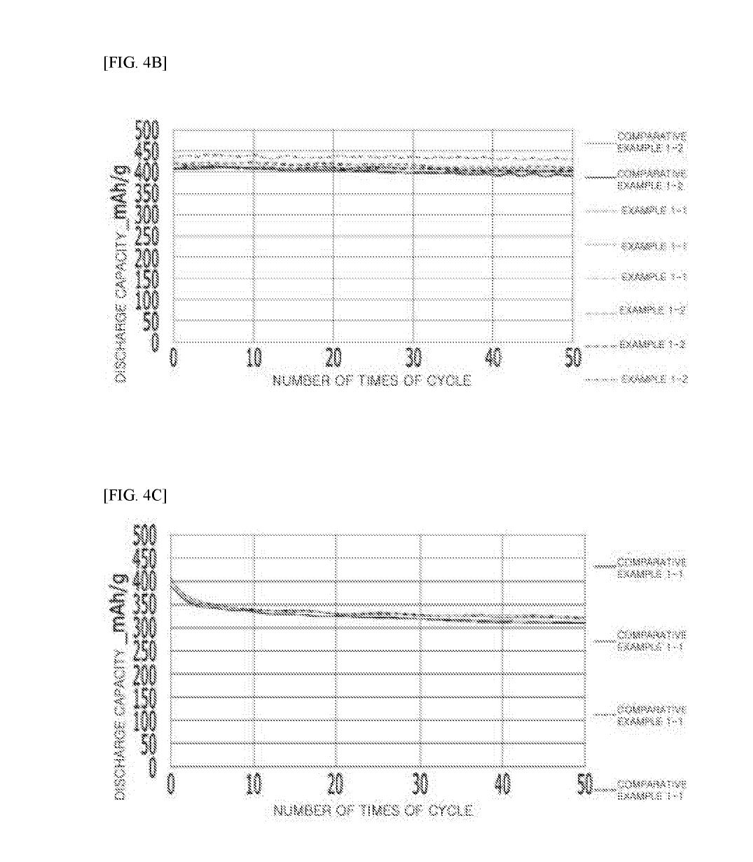

A charging/discharging evaluation was performed on the negative plates for the lithium secondary battery manufactured in Example 1 and Comparative Example 2. Particularly, after once performing charging/discharging on the negative plate manufactured in a coin shape, a plate capacity (mAh/g) and a capacity of the active material (mAh/g, a capacity obtained by dividing the plate capacity by the ratio of the negative active material added) and initial efficiency (%) was measured, and the measurement result is represented in FIG. 3.

Referring to FIG. 3, it can be seen that the negative plate for the lithium secondary battery of Example 1-1 (the negative plate, in which the ratio of the SWCNT dispersion liquid to the silicon (Si) alloy is 800:3) has more excellent plate capacity and excellent efficiency than those of the negative plates for the lithium secondary battery of Comparative Examples 1-1 and 1-2 (the negative plate, in which the SWCNT dispersion liquid is not added, and the negative plate, in which the ratio of the SWCNT dispersion liquid to the silicon (Si) alloy is 800:1). Based on the fact, it can be seen that when the SWCNT dispersion liquid is added so that the ratio of the SWCNT dispersion liquid to the silicon (Si) alloy is 800:3, a plate capacity and efficiency are improved. Further, it can be seen that negative plates for the lithium secondary battery of Examples 1-2, 1-3, and 1-4 commonly exhibit an excellent plate capacity and excellent initial efficiency.

Referring to FIG. 3, a plate capacity and initial efficiency of the negative plate for the lithium secondary battery of Comparative Examples 1-3 (the negative plate, in which the ratio of the SWCNT dispersion liquid to the silicon (Si) alloy is 16:1) are degraded compared to the negative plate for the lithium secondary battery of Examples 1-4 (the negative plate, in which the ratio of the SWCNT dispersion liquid to the silicon (Si) alloy is 80:3). Based on the fact, it can be seen that when the ratio of the SWCNT dispersion liquid to the silicon (Si) alloy exceeds about 20:1, a plate capacity and efficiency are rather degraded. Although not limited by a theory, when the ratio of the SWCNT dispersion liquid to the silicon (Si) alloy exceeds about 20:1, irreversible properties of the components configuring the negative plate are increased, so that it seem that a plate capacity and efficiency are degraded.

Based on the numerical values represented in FIG. 3, it can be seen that a capacity and initial efficiency of the negative plate for the lithium secondary battery may be improved only when the ratio of the SWCNT dispersion liquid to the silicon (Si) alloy is at least 800:3 to 20:1, preferably, 160:1 to 80:3.

2. Cycle Life Characteristic

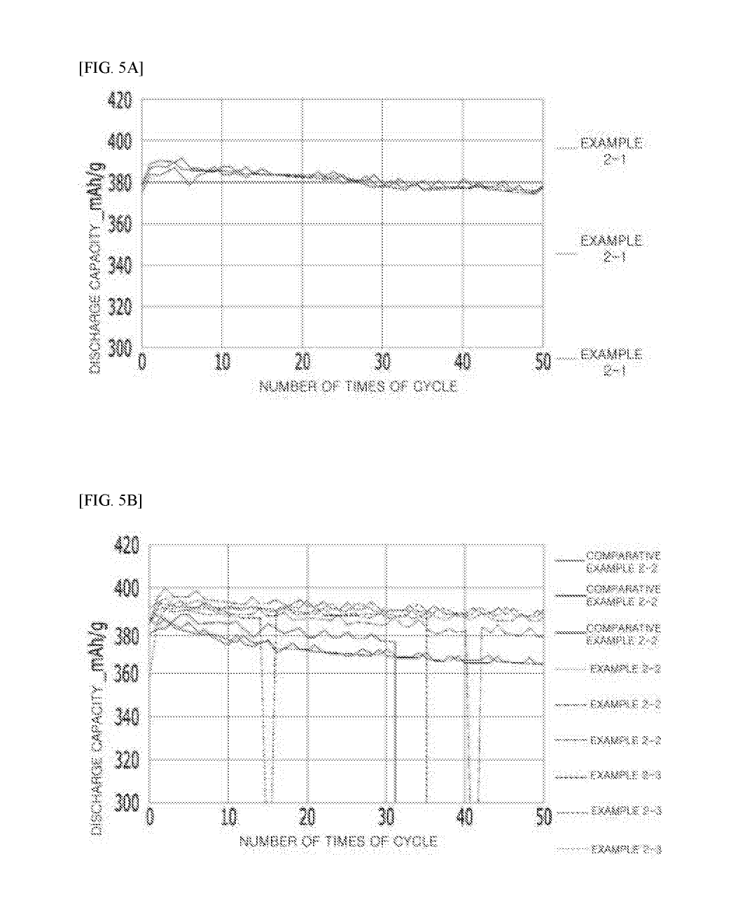

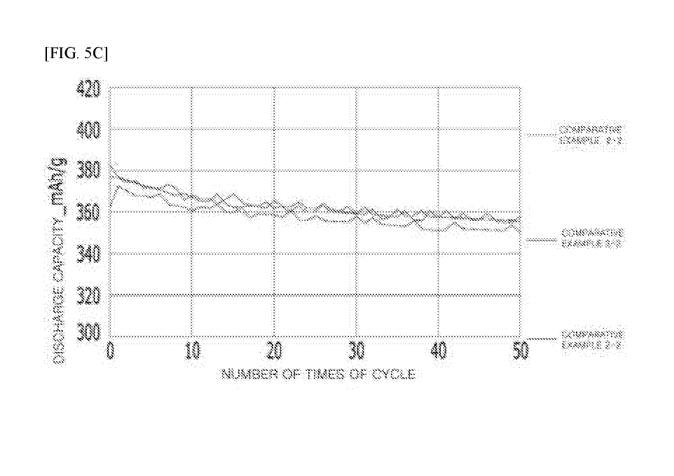

Cycle life characteristics of the negative plates for the lithium secondary battery manufactured in Example 1 and 2, and Comparative Examples 1 and 2 were measured. Particularly, cycle life characteristics of the coin-shaped negative plates for the lithium secondary battery manufactured in Example 1 and 2, and Comparative Examples 1 and 2 were measured by repeating charging/discharging 50 times at 0.5 C. The charging/discharging method was performed based on a charging/discharging method for an active material for a lithium secondary battery which is generally and publicly known in the art. The measurement results are illustrated in FIGS. 4A to 4C, and FIGS. 5A to 5C.

Particularly, FIG. 4A illustrates life characteristics of the negative plates of Examples 1-1 and 1-2, and Comparative Example 1-2, FIG. 4B illustrates life characteristics of the negative plates of Examples 1- and 1-4, and Comparative Example 1-3, and FIG. 4C illustrates life characteristics of the negative plate of Comparative Example 1-1. Further, FIG. 5A illustrates life characteristics of the negative plate of Examples 2-1, FIG. 5B illustrates life characteristics of the negative plates of Examples 2-2 and 2-3, and Comparative Example 2-2, and FIG. 5C illustrates life characteristics of the negative plate of Comparative Example 2-1.

Referring to FIGS. 4A to 4C, there is little difference in a life difference between the negative plate of Comparative Example 1-1 (the negative plate, in which the SWCNT dispersion liquid is not added) and the negative plate of Comparative Example 1-2 (the negative plate, in which the ratio of the SWCNT dispersion liquid to the silicon (Si) alloy is 800:1), but the negative plate of Example 1-1 (the negative plate, in which the ratio of the SWCNT dispersion liquid to the silicon (Si) alloy is 800:3) has little difference in a capacity even after 50 times of the charging/discharging, so that it can be seen that the life characteristic of the negative plate of Example 1-1 is considerably improved compared to the negative plates of Comparative Examples 1-1 and 1-2. Further, it can be seen that the negative plates of Examples 1-2, 1-3, and 1-4 (the negative plates, in which the ratio of the SWCNT dispersion liquid to the silicon (Si) alloy is 800:3 to 80:3) commonly exhibit an excellent life characteristic.

In the meantime, referring to FIG. 4B, it can be seen that the negative plate of Comparative Example 1-3 (the negative plate, in which the ratio of the SWCNT dispersion liquid to the silicon (Si) alloy is 16:1) also exhibits an excellent life characteristic.

Referring to FIGS. 5A to 5C, there is little difference in a life difference between the negative plate of Comparative Example 2-1 (the negative plate, in which the SWCNT dispersion liquid is not added) and the negative plate of Comparative Example 2-2 (the negative plate, in which the ratio of the SWCNT dispersion liquid to the silicon (Si) alloy is 580:1), but the negative plate of Example 2-1 (the negative plate, in which the ratio of the SWCNT dispersion liquid to the silicon (Si) alloy is 580:3) has little difference in a capacity even after 50 times of the charging/discharging, so that it can be seen that the life characteristic of the negative plate of Example 2-1 is considerably improved compared to the negative plates of Comparative Examples 2-1 and 2-2. Further, it can be seen that the negative plates of Examples 2-2 and 2-3 (the negative plates, in which the ratio of the SWCNT dispersion liquid to the silicon (Si) alloy is 116:1 to 58:1) commonly exhibit an excellent life characteristic.

Based on the numerical values represented in FIGS. 4 and 5, it can be seen that the life characteristic of the negative plate for the lithium secondary battery is improved only when the ratio of the SWCNT dispersion liquid to the silicon (Si) alloy is at least 800:3 or more, preferably, 160:1 or more.

As the result of the analysis of the data for the plate capacity, the initial efficiency, and the life characteristic, it can be seen that the capacity, the initial efficiency, and the life characteristic of the negative plate for the lithium secondary battery is improved only when the ratio of the SWCNT dispersion liquid to the silicon (Si) alloy is at least 800:3 to 20:1, more particularly, 160:1 to 80:3 (although the ratio of the SWCNT dispersion liquid to the silicon (Si) alloy is 20:1 or more, the life characteristic may be improved, but the capacity and the initial efficiency are degraded, so that that it may be considered to be preferable that the ratio of the SWCNT dispersion liquid to the silicon (Si) alloy is 20:1 or less).

The exemplary embodiments of the present invention have been described in more detail with reference to the accompanying drawings, but the present invention is not essentially limited to the exemplary embodiments, and may be variously modified and carried out within the scope of the technical spirit of the present invention. Accordingly, the various exemplary embodiments disclosed herein are not intended to limit the technical spirit but describe with the true scope and spirit being indicated by the following claims. The scope of the present invention should be construed based on the following appended claims and it should be construed that the technical spirit included within the scope equivalent to the claims belongs to the present invention.

1. A negative plate for a lithium secondary battery, comprising:
a negative active material including a silicon (Si) alloy;
a binder; and
a single-walled carbon nano tube (SWCNT) dispersion liquid, wherein the ratio of the SWCNT dispersion liquid to the silicon (Si) alloy included in the negative plate for the lithium secondary battery is 800:3 to 20:1.

2. The negative plate of claim 1, wherein the ratio of the SWCNT dispersion liquid to the silicon (Si) alloy included in the negative plate for the lithium secondary battery is 160:1 to 80:3.

3. The negative plate of claim 1, wherein silicon (Si) is included in the silicon (Si) alloy by 40 at % to 70 at %.

4. The negative plate of claim 1, wherein the negative active material further includes graphite.

5. The negative plate of claim 1, wherein the binder is included in the negative plate for the lithium secondary battery by 1 to 10 at %.

6. The negative plate of claim 1, further comprising:
a thickener of 0.01 to 2 at %.

7. The negative plate of claim 1, further comprising:
a conductive agent of 0.01 to 5 at %.
